(19) United States
(12) Patent Application Publication
(10) Pub. No.: US 2004/0021733 A1
(43) Pub. Date: Feb. 5, 2004

(54) Digital printing

(76) Inventor: James George Lowndes, Western Cape (ZA)

Correspondence Address: LADAS & PARRY, 26 WEST 61ST STREET, NEW YORK, NY, 10023, US

(21) Appl. No.: 10/363,103

(22) PCT Filed: Aug. 28, 2001
(86) PCT No.: PCT/ZA01/00125

(30) Foreign Application Priority Data
Aug. 31, 2000 (ZA) 2000/4532

(51) Int. Cl. B41J 2/21

(52) U.S. Cl. 347/43

(57) ABSTRACT

A method of digital printing which comprises applying ink microdots to a surface, the inks used comprising black, magenta, cyan, a first yellow that is to the lemon shade side of Pantone Process yellow and a second yellow that is to the orange shade side of Pantone Process yellow.

### FIELD OF THE INVENTION

THIS INVENTION relates to digital colour printing.

### BACKGROUND TO THE INVENTION

There are two widely used methods of producing coloured images making use of computer controlled digital printers. The first of these is known as the Pantone Process. The printer has four sets of nozzles which eject streams of microdots of ink in four colours. The four colours used are cyan, magenta, yellow and black. The second method, called the Hexachrome process, comprises the use of six sets of nozzles which eject streams of microdots in the colours listed plus orange and green. In certain cases a light cyan and a light magenta are used together with the traditional cyan, magenta, yellow and black to assist in obtaining a smooth overall print result without light and dark streaking of the cyan and magenta colours.

The present invention seeks to provide a further method of digital colour printing.

### BRIEF DESCRIPTION OF THE INVENTION

According to one aspect of the present invention there is provided a method of digital printing in which ink microdots are applied to a surface, the inks used being black, magenta, cyan, a first yellow hue such as can be obtained by adding a white pigment to Pantone Process yellow and a second yellow hue such as can be obtained by adding a red pigment to Pantone Process yellow.

According to a further aspect of the present invention there is provided a method of digital printing which comprises applying ink microdots to a surface, the inks used being black, magenta, cyan, a first yellow and a second yellow, one of the yellows being more orange in hue than the other.

According to another aspect of the present invention there is provided a method of digital printing which comprises applying ink microdots to a surface, the inks used comprising black, magenta, cyan, a first yellow that is to the lemon shade side of Pantone Process yellow and a second yellow that is to the orange shade side of Pantone Process yellow.

According to yet another aspect of the present invention there is provided a method of printing a graphic which comprises creating a computer program which represents the graphic in five colours and using said computer program to control the application to a surface of ink microdots in accordance with the program, the colours by which the graphic is represented being black, cyan, magenta, a first yellow and a second yellow, one of the yellows being more orange in hue than the other.

The present invention also provides inks for use in performing the method defined above, the inks being black, magenta, cyan, a first yellow and a second yellow, one of the yellows being more orange in hue than the other.

A digital printer having five sets of nozzles for ejecting ink microdots onto a surface can be used to perform the method of the present invention.

### DETAILED DESCRIPTION OF THE INVENTION

It is traditionally difficult to achieve a wide range of the red colour gamut and at the same time achieve a wide range of the green colour gamut. Normally, to achieve a better red gamut, a sacrifice must be made in the green gamut and vice versa. This invention is intended to achieve a wide red gamut together with a wide green gamut whilst utilising only five colours. It is commonly known that the yellow in combination with cyan results in green, and yellow in combination with magenta results in red. Yellow is thus the most important colour to complete the range of the red gamut and of the green gamut. Yellow shades are available which can be selected and which influence the shade of the red or green gamut. It is also generally accepted that a more “lemon” yellow results in a better green gamut but results in limitations in the red gamut. A “warm” or “orange” yellow results in a better red gamut but imposes limitations on the Green gamut. Pantone Process yellow, which is used in most traditional printing methods, is a compromise and its shade is in between the “lemon” and the “orange” yellows.

This invention incorporates both “lemon” and the “warm” yellows together with the traditional cyan, magenta and black into the digital printing process. This allows the full colour gamuts to be obtained for the green and red colours. The ability to incorporate these five colours into the printing process improves the colour spectrum. The software which drives the printer distinguishes between green and red and selects the appropriate lemon yellow or orange yellow to achieve the desired colour or combinations of colours.

Commercially available forms of printers which print using four or six sets of nozzles, and four or six ink reservoirs each of which supplies ink to a set of nozzles, are currently utilised in the printing industry.

The object of the present invention can be achieved by adding a further set of nozzles and a further ink reservoir to digital printers which have four sets of nozzles and four ink reservoirs, and filling the five reservoirs with inks of the colours defined.

The following are examples of yellows that can be used as the lemon yellow and orange yellow:—

Lemon Yellows

Ciba—C1 No 20710 pigment yellow 93

Clariant—C1 No 13980 yellow 151

BASF—C1 No 56290 pigment yellow 185

Pantone 100

Pantone 101

Pantone 102

Pantone 106

Orange Yellows

Ciba—C1 No 21108 pigment yellow 83

Ciba—C1 No 5628 pigment yellow 110

Pantone 108 Pantone 1235

Pantone 109 Pantone 129

Pantone 116 Pantone 130

Pantone 115 Pantone 136

Pantone 122 Pantone 137

Pantone 123 Pantone 138

Pantone 1225 Pantone 151

Pantone 1505

The Pantone numbers are from the 1997 Pantone colour guide.

1. A method of digital printing in which ink microdots are applied to a surface, the inks used being black, magenta, cyan, a first yellow hue such as can be obtained by adding a white pigment to Pantone Process yellow and a second yellow hue such as can be obtained by adding a red pigment to Pantone Process yellow.

2. A method of digital printing which comprises applying ink microdots to a surface, the inks used being black, magenta, cyan, a first yellow and a second yellow, one of the yellows being more orange in hue than the other.

3. A method of digital printing which comprises applying ink microdots to a surface, the inks used comprising black, magenta, cyan, a first yellow that is to the lemon shade side of Pantone Process yellow and a second yellow that is to the orange shade side of Pantone Process yellow.

4. A method of printing a graphic which comprises creating a computer program which represents the graphic in five colours and using said computer program to control the application to a surface of ink microdots in accordance with the program, the colours by which the graphic is represented being black, cyan, magenta, a first yellow and a second yellow, one of the yellows being more orange in hue than the other.

5. A print when produced by the method claimed in claims 1, 2, 3 or 4.

6. A digital printer for performing the method claimed in claims 1, 2, 3 or 4 and having five sets of nozzles for ejecting ink microdots onto a surface.

7. An ink supply for use in performing the method defined above, the inks being black, magenta, cyan, a first yellow and a second yellow, one of the yellows being more orange in hue than the other.
